(19) United States
(12) Patent Application Publication
(10) Pub. No.: US 2013/0268593 A1
(43) Pub. Date: Oct. 10, 2013

(54) DETERMINING MUSIC IN SOCIAL EVENTS VIA AUTOMATIC CROWDSOURCING

(71) Applicant: Neel B. Parekh, Sunnyvale, CA (US)

(72) Inventor: Neel B. Parekh, Sunnyvale, CA (US)

(73) Assignee: Google Inc., Mountain View, CA (US)

(21) Appl. No.: 13/443,806

(22) Filed: Apr. 10, 2012

(51) Int. Cl. G06F 15/16

(52) U.S. Cl. 709/204

(57) ABSTRACT

A method for providing music to a group of users is provided. The method initiates with detecting a plurality of devices in proximity to each other, each of the devices having an associated user. For each user, a music library of the user is accessed to retrieve a listing of songs contained in the music library and data associated with each of the songs. The retrieved listings of songs and the associated data are analyzed to determine songs which are likely to be preferred by all of the users. A group playlist of songs is generated based on the songs which are likely to be preferred by all of the users. The songs of the group playlist are then streamed to one of the plurality of devices.

### BACKGROUND

The present disclosure relates to methods, systems, and computer programs for determining music in social events via automatic crowdsourcing.

### DESCRIPTION OF THE RELATED ART

Internet applications have grown tremendously over the years and so have the functionality provided to devices that access those applications. One area that has seen such growth relates to audio file management. As users continue to purchase and store more audio music files on their devices, management of those files becomes ever more important. Commonly, users have music libraries on various devices and those devices are usually backed up from time to time. If a user has more than one device, more synchronization is necessary to ensure that each device has access to the desired music. As users upgrade their devices or lose their devices, added complexities arise in syncing new devices to older music libraries. Many times, the management becomes so extensive that users lose some or most of their libraries.

To address these issues, services are now being provided to allow online cloud storage of their music files. However, improvement is still needed to address various challenges posed by cloud storage. It is in this context that embodiments arise.

### SUMMARY

Embodiments of the present invention provide methods, systems, and computer programs for determining music in social events via automatic crowdsourcing. It should be appreciated that the present invention can be implemented in numerous ways, such as a process, an apparatus, a system, a device or a method on a computer readable medium. Several inventive embodiments of the present invention are described below.

In one embodiment, a method for providing music to a group of users is provided. The method includes method operations of: detecting a plurality of devices in proximity to each other, each of the devices having an associated user; for each user, accessing a music library of the user to retrieve a listing of songs contained in the music library and data associated with each of the songs; analyzing the retrieved listings of songs and the associated data to determine songs which are likely to be preferred by all of the users; generating a group playlist of songs based on the songs which are likely to be preferred by all of the users; and streaming the songs of the group playlist to one of the plurality of devices.

In one embodiment, analyzing the retrieved listings of songs includes determining commonly owned songs amongst the users.

In one embodiment, the data associated with each of the songs includes one or more of a rating and a playcount, and analyzing the associated data includes analyzing the ratings or playcounts of songs.

In one embodiment, the data associated with each of the songs includes one or more of an artist and a genre, and analyzing the associated data includes analyzing the artists or genres of songs to determine artists or genres which are popular amongst the users.

In one embodiment, analyzing the retrieved listings of songs and the associated data includes determining unique songs amongst the listings of songs, and for each unique song, determining a group preference value based on one or more of the following: a number of the users' libraries that contain the unique song, ratings associated with the unique song, and playcounts associated with the unique song.

In one embodiment, detecting the plurality of devices in proximity to each other includes detecting the plurality of devices over a local area network.

In one embodiment, detecting the plurality of devices in proximity to each other includes activating one or more of Bluetooth communication, near-field communication, a geo-location service.

In another embodiment, a method for providing music to a group of users is provided. The method includes method operations of: detecting a first device associated with a first user, the first user having an online music library; detecting a second device associated with a second user in a vicinity of the first device, the second user having an online music library; retrieving data from the online music library of the first user and data from the online music library of the second user; analyzing the retrieved data to determine songs contained within either of the first user's music library or the second user's music library which are likely to be preferred by both the first and second users; and streaming the songs which are likely to be preferred by both the first and second users.

In one embodiment, the data retrieved from the online music libraries of the first and second users includes metadata associated with songs stored in each of the music libraries.

In one embodiment, the metadata defines one or more of a title, an artist, a genre, a rating, and a playcount.

In one embodiment, streaming the songs includes determining, for a song to be streamed, one of the music libraries containing the song to be streamed, and retrieving the song to be streamed from the one of the music libraries.

In one embodiment, detecting the first device includes determining a location of the first device, and detecting the second device in the vicinity of the first device includes determining a location of the second device and determining a distance between the location of the first device and the location of the second device.

In one embodiment, detecting the second device in the vicinity of the first device includes detecting a communication between the first device and the second device over one of a local area network, a near-field communication, or a Bluetooth communication.

In another embodiment, a method for providing music to a group of users is provided. The method includes method operations of initiating a group play mode at a first device, the first device associated with a first user having a first music library, the initiation of the group play mode establishing a group of users; receiving from a second device a request to join the group of users, the second device associated with a second user having a second music library; adding the second user to the group of users; initiating an analysis of the music libraries of the users in the group of users to determine a ranked order of songs in the music libraries, the ranked order indicating a relative likelihood of the songs to be preferred by all of the users in the group of users; and receiving a streamed group playlist of songs, the songs of the group playlist being selected based on the ranked ordering of songs.

In one embodiment, adding the second user to the group of users includes sending an acknowledge to the second device, receipt of the acknowledge at the second device disabling local playback from the second music library at the second device.

In one embodiment, the music libraries of the users are stored remotely or stored locally.

In one embodiment, the analysis of the music libraries to determine the ranked order of songs includes analyzing metadata associated with songs contained in the music libraries.

In one embodiment, the request to join the group of users is received from the second device via one or more of a remote server, a local area network, and a direct wireless connection.

Other aspects will become apparent from the following detailed description, taken in conjunction with the accompanying drawings.

### BRIEF DESCRIPTION OF THE DRAWINGS

The invention may best be understood by reference to the following description taken in conjunction with the accompanying drawings.

FIG. 1 illustrates a system diagram for enabling access and playing of music files stored in cloud storage, in accordance with one embodiment of the present invention.

FIG. 2 illustrates how user A utilizes a device 106 (e.g. smart phone) to access his or her music library stored in the cloud music storage (CMS) 116, in accordance with one embodiment of the present invention.

FIG. 3 illustrates how a user may upload music to their cloud-based music library, in accordance with an embodiment of the invention.

FIG. 4 illustrates a system for enabling a plurality of users to generate and stream a group playlist based on songs which are contained within the users' music libraries, in accordance with an embodiment of the invention.

FIG. 5 illustrates a group play mode carried out over a local area network, in accordance with an embodiment of the invention.

FIG. 6 illustrates systems for data retrieval and playlist generation, in accordance with an embodiment of the invention.

FIG. 7 illustrates automatic detection of devices in a vicinity of each other for a group play mode, in accordance with an embodiment of the invention.

FIG. 8 illustrates one example of a plurality of users' music libraries containing songs which are analyzed to determine a group playlist, in accordance with an embodiment of the invention.

FIG. 9 illustrates timelines of operations associated with various devices, in accordance with an embodiment of the invention.

FIG. 10A illustrates a method for determining songs for inclusion in a group playlist, in accordance with an embodiment of the invention.

FIG. 10B illustrates intersections of library data nodes for determining songs which are likely to be preferred by a group of users, in accordance with an embodiment of the invention.

FIG. 11A illustrates group playback in the context of a vehicle, in accordance with an embodiment of the invention.

FIG. 11B illustrates regionally disparate clusters of users participating in the same group playlist streaming event, in accordance with an embodiment of the invention.

FIG. 12 illustrates a series of interface views for configuring a group play mode, in accordance with an embodiment of the invention.

FIG. 13 is a simplified schematic diagram of a computer system for implementing embodiments of the present invention.

### DETAILED DESCRIPTION

The following embodiments describe methods, computer programs, and systems for determining music in social events via automatic crowdsourcing. Broadly speaking, when a group of persons gathers together, as may occur at a social event or other type of event, it can be difficult to determine music that will be suitable to everyone's tastes. However, if each of the users has an associated music library, then their music libraries can be collectively analyzed to determine music that is likely to be enjoyed by as many of the users within the group of users as possible. Various aspects of the users' music libraries can be analyzed, such as their content, indicated preferences, and play history, to generate a crowd-sourced group playlist of songs.

It will be apparent, that the present embodiments may be practiced without some or all of the specific details disclosed herein. In other instances, well known process operations have not been described in detail in order not to unnecessarily obscure the present embodiments.

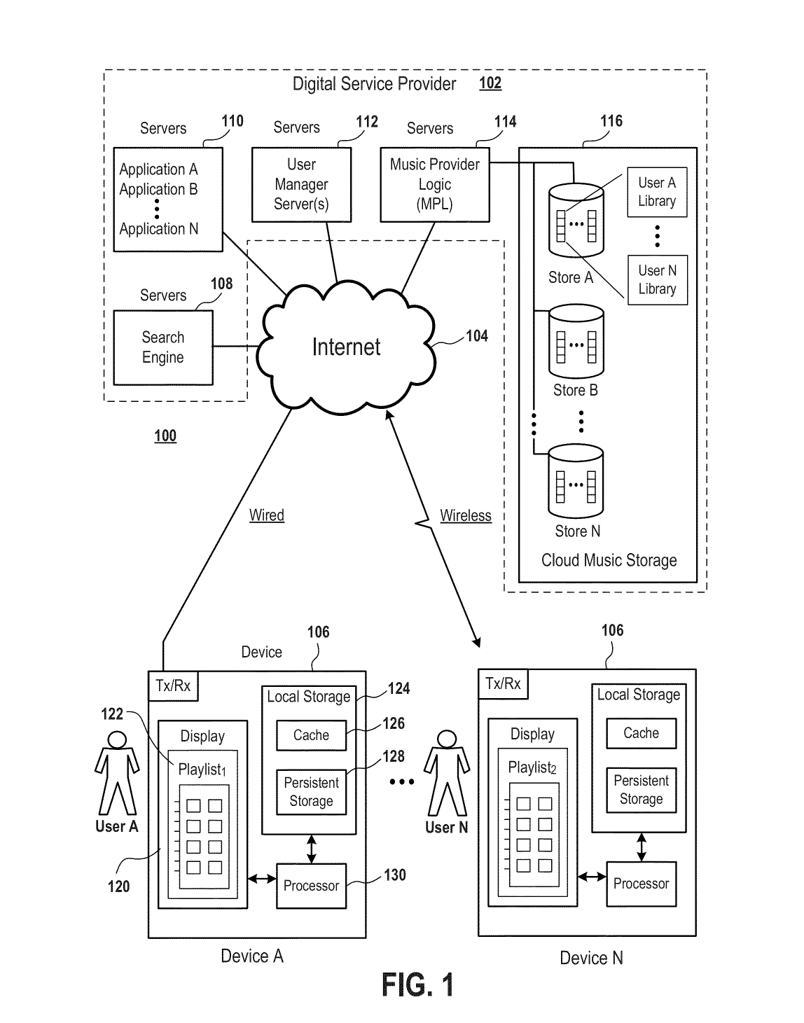

FIG. 1 illustrates a system diagram 100 that defines methods for accessing and playing music files stored in cloud storage, and improving the rate at which playing of a music file response to user selection, is disclosed in accordance with one embodiment of the present invention. The system includes a plurality of servers that are connected to the Internet 104. The plurality of servers and storage are, in one embodiment, part of a digital service provider 102. The digital service provider 102, is a system that can include a plurality of servers that can provide applications, services, digital content, and interconnectivity between systems, applications, users, and social networks. For example, the digital service provider 102 can include a search engine 108, a plurality of servers 110 that provide applications for various business, social, and technology related subject matter, servers that provide user management 112, and servers to provide music related services.

One example digital service provider 102 can be Google Inc., of Mountain View, Calif. Other digital service providers can be more focused to provide only specific services, while others provide a variety of services for access, download, viewing, searching, etc. The content can vary greatly, but is commonly presented in digital format and generally displayed on monitors or screens of devices, computers, smart phones, tablets, etc. Content may also be presented through other mechanisms, such as audio content presented through speakers or headphones.

The servers that provide music related services, in one embodiment, are illustrated by the music provider logic (MPL) 114, that executes over one or more servers that are connected to the Internet 104. The music provider logic 114 is shown connected to cloud music storage 116. Cloud music storage 116 is shown to include a plurality of storage systems, identified as store A, store B, and store N. The various storage systems that hold music data and music metadata, are provided with fast access to the Internet, for providing music data on demand to users requiring access to their music library stored in cloud music storage 116. In one embodiment, users can access the cloud music storage 116 by way of a plurality of devices 106. The plurality of devices can include any type of device having a processor and memory, wired or wireless, portable or not portable. In the example illustrated in FIG. 1, user A is shown to have device 106 (device A). Device 106 is shown to include communication logic for transmitting and receiving data between device 106 and the Internet 104.

The communication logic (Tx/Rx) can include various types of network interface circuitry, radio-communication (e.g. wireless), cell tower communication, or interconnected wiring connected to Internet service providers. Device 106 is also shown to include a display having a screen 120, local storage 124, and a processor 130. Local storage 124 can include cache memory 126, persistent storage 128, and other logic. In this example, device 106 is shown to include graphical icons (e.g., graphical user interfaces GUIs) that represent a play list. The screen 120 can be a touch-screen, or a display typically provided by a flat-panel display, a cathode ray tube (CRT), or other media capable of rendering a display. Still further, device 106 can have its display separate from the device, similar to a desktop computer or a laptop computer. Still further yet, device 106 can be in the form of a smart phone, a tablet computer, or hybrids that provide touch-screen capability in a portable form factor. One example device can include a portable phone device that runs an operating system and is provided with access to various applications (apps) that may be obtained over the Internet, and executed on the local portable device (e.g., smart phone, tablet, laptop, desktop, etc.). In still other embodiments, the device 106 can be a screenless device that is capable of accessing and playing music.

In one embodiment, the user of device 106 can install an application that provides cloud storage of music files, and access to the storage cloud music files from the device 106. Once the user's music files are uploaded to the cloud music storage 116, the user's music files are associated to a library of the user. In one embodiment, a plurality of users can access the same application and can upload their own music files to create their own library, which will be stored in the cloud music storage 116.

Each of such users can then access the cloud music storage 116 through an application on their device 106 to render and play selected music files on their device, when the device 106 has access to the Internet and associated servers of the music providing logic 114 and cloud music storage 116. Accordingly, users can access the music application on their device 106, access all music files stored in cloud music storage 116, arrange music titles in their music library into playlists, add music to the cloud music storage 116, delete music from the cloud music storage 116, and purchase music that is added to the cloud music storage 116. These changes are maintained and managed by the music provider logic 114 and music provider logic 114 will provide access to the various users to their music files stored in the cloud music storage 116, based on their selections during use of the application.

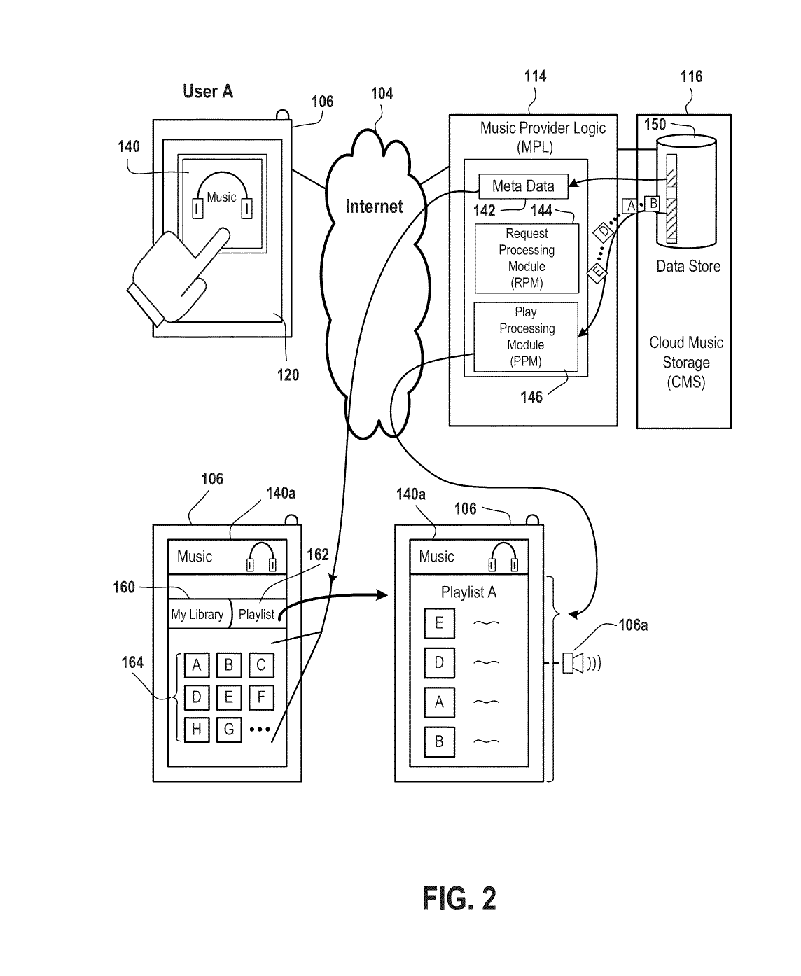

FIG. 2 illustrates how user A utilizes a device 106 (e.g. smart phone) to access his or her music library stored in the cloud music storage (CMS) 116, in accordance with one embodiment of the present invention. As shown, the device 106 will include a screen 120, and associated graphical icons that present a thumbnail of an application 140, associated with a music application. Application 140, as described herein, relates to an application that provides a user with access to his or her music library which has been previously added to the club music storage 116. If the user is a new user to the application 140, the new user can download application 140 to device 106 from at least one server 110 of the digital service provider 102. In another embodiment, the application 140 may be preinstalled on the device.

Once the application has been downloaded and installed on device 106, the icon representing application 140 will be rendered on the display screen of device 106. Initially, the user will be prompted to select music to add to the cloud music storage 116. The music may be added from files currently maintained by the user on his or her device 106, on other devices of the user such as computers, other smart phone and or tablets, or other storage media. Additionally, the user can add music files that may be part of a music library maintained by another application. The other application may maintain a specific format for the music, and the music can be obtained and translated to standardize music files for addition to the cloud music storage 116.

Once the user has managed his library to add, modify, or adjust the music files present in the cloud music storage 116, the user can access application 140 and various options from graphical user interfaces provided on the screen 120 of device 106. In the illustrated example, device 106 will open application 140 through various graphical user interface screens, such as interface 140a. Interface 140a can include various menus, selection icons, configuration icons, displays, advertisements, buttons, listings, etc. In this example, the interface 140a may include an icon that lists the users library 160, the users play list 162, and music title icons 164. Music title icons can be represented by graphical artwork that represents artwork associated with the various music files present in the users library. The users library is illustrated by title icons 164, shown as A-H.

The title icons 164 are rendered on the screen 120 upon obtaining metadata from the cloud music storage 116, which may be present in data store 150. Music provider logic 114 will include request processing module 144 that manages the requests and communication between various users applications 140 and the cloud music storage 116. The request processing module (RPM) 144 is also in communication with a play processing module (PPM) 146. In order to render the title icons 164 on the screen of the device 106, the music processing logic 114 will utilize the request processing module 144 to obtain metadata 142 from the data store 150.

The metadata 142 will be the metadata associated with the various music files stored in data store 150 for the requesting user. The metadata 142 provides information regarding each of the titles stored in the cloud music storage 116, and sufficient information to render the title icons 164 on the screen of device 106, and provide text information, duration information, genre information, and other data that describes aspects or characteristics of the music files. One example of metadata is an ID3 tag, which can contain information such as title, artist, album, year, track number, genre, etc. As shown, when the user selects play list 162 on device 106, a play list graphical user interface is shown identifying particular songs that have been arranged by the user.

The playlist A represents various songs that were selected by the user to be part of playlist A. The user can have various playlists, and the selection of playlist A is only provided as one example of a playlist that includes music files that are played in the order E→D→A→B. Once the user selects a corresponding play button or clicks on one of the audio files in the playlist, the music files will begin to play in the order arranged and defined by the user in his or her playlist A.

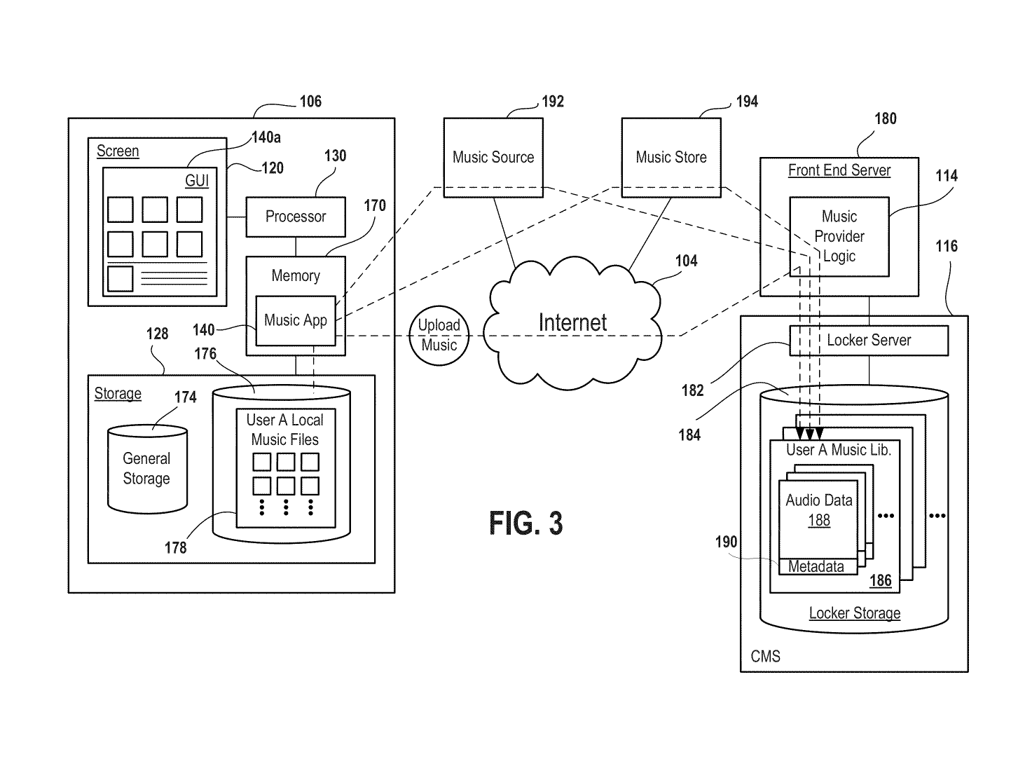

FIG. 3 illustrates how a user A may upload music to their cloud-based music library, in accordance with an embodiment of the invention. As shown, the music application 140 is executed in a memory 170 of the device 106. The device 106 includes persistent storage 128 which contains general storage 174 and local music storage 176. The local music storage 176 includes various music files 178 which the user A has stored on the device 106. The music application 140 provides an interface 140a shown on the display 120 of the device 106, which enables the user A to manually or automatically upload one or more of the music files 178 to the user's music library 186.

In one embodiment, the music application 140 detects the music files 178 and communicates with the music provider logic 114 via the Internet 104. The music provider logic 114 executes on a front end server 180. The music provider logic 114 communicates with a locker server 182 which manages access to a locker storage 184. The locker storage 184 contains various users' individual music libraries, including user A's music library 186. The music library 186 includes various audio files, each of which is defined by audio data 188 and associated metadata 190. Thus, in one embodiment, the music application 140 transmits one or more of the locally stored music files 178 to the music provider logic 144 which accesses the locker server 182 to store the music files within the user's music library 186.

It will be noted that music files from various other sources may also be uploaded to the user's music library 186. For example, music files from an external music source 192 that is available via the Internet 104 can be uploaded to the user's music library 186. In one embodiment, the music application 140 enables the user A to access, listen to, and authorize uploading of a music file from the external source 192. One example of an external music source is an online music store 194, from which the user A may purchase music for downloading to the user's music library. It will be appreciated that in the illustrated embodiment, by purchasing music from the music store 194, the user A causes a music file to be transferred from the music store 194 to the user A's music library 186. This is distinguished from a conventional online purchase where data is transferred to the user's client device. In the presently described embodiment, the data is transferred to a cloud-based storage library, which the user then accesses utilizing a client device 106.

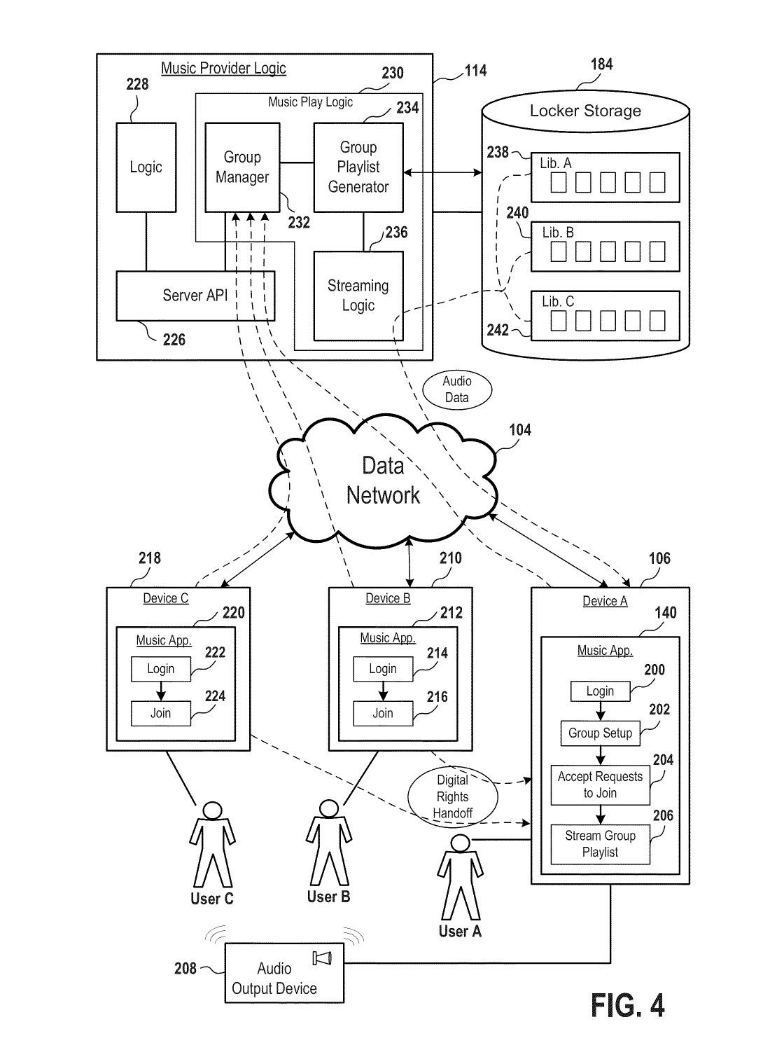

FIG. 4 illustrates a system for enabling a plurality of users to generate and stream a group playlist based on songs which are contained within the users' music libraries. In the illustrated embodiment, user A, user B, and user C are present in the vicinity of each other, such as may occur at a social event or other gathering. Each of the users A, B, and C, is associated with a device 106, device 210, and device 218, respectively. As such, the devices 106, 210, and 218, are also within the vicinity of each other. Additionally, each of the users A, B, and C has an associated music library 238, 240, and 242, respectively. The users are able to access their music libraries via a music application which executes on their corresponding devices. In the illustrated embodiment, music application 140 executes on device 106 to enable user A to access music library 238, whereas music application 212 executes on device 210 to enable user B to access music library 240, and music application 220 executes on device 218 to enable user C to access music library 242. In order to access the music libraries, the music applications communicate with music provider logic 114 via data network 104, interfacing with a server API 226 in one embodiment.

In accordance with one embodiment, a sequence of events for a group play mode enabling generation and playback of a group playlist will now be described. The music provider logic 114 includes group play logic 234 managing the group play mode. Initially, each of the users A, B, and C executes a login operation 200, 214 and 222, respectively. The login operation authenticates the users to the music provider logic 114, and is handled by a login module 228. By way of example, the login operation may require communication and verification of a user ID and password associated with a given user. In the illustrated embodiment, the user A initiates a group set up operation 202. In response, a group manager 232 initiates a group containing at least the user A. Meanwhile, users B and C execute join operations 216 and 224, respectively to join the group that has been setup by user A.

It will be appreciated that the process for facilitating setup and addition of users to a group for the group play mode may proceed according to a variety of configurations in accordance with various embodiments. For example, in one embodiment, when the user A performs the group setup operation 202, the group manager 232 instantiates a group associated with user A's user ID. Then when user B or C wishes to join user A's group, they may enter user A's user ID and request to join user A's group. The user A may then accept user B and C's requests to join the group at operation 204, whereupon the group manager 232 adds users B and C to user A's group. In another embodiment, when user A performs the group setup, user A determines a group ID and optional passcode for joining the group. Then when users B and C wish to join the group, they may enter the group ID and optional passcode in order to join. In still another embodiment, the corresponding music applications of users B and C may include an auto-detection function which detects a nearby user who is “hosting” a group. Detection of nearby users can be accomplished utilizing a variety of technologies, including detection on a local network, GPS localization or geo-location service, Bluetooth communications, near field communications (NFC), etc. In the illustrated embodiment, users' B and C's devices would detect that user A is in their vicinity and hosting a group, and would present to users' B and C an option to join user A's group.

Once the users have joined the group, user A initiates streaming of a group playlist at operation 206. The group playlist is generated by a group playlist generator 234, which analyzes the music libraries of the users in the group in order to determine songs which are likely to be preferred or enjoyed by as many of the users in the group as possible. In one embodiment, this may be determined based on satisfaction of a preference metric. In order to determine which songs to include in the group playlist, the group playlist generator may analyze a variety of factors, including the following: which songs are commonly owned amongst the users (i.e. songs which are included in two or more of the music libraries associated with the users in the group); which artists are commonly owned amongst the users; which genres of music are commonly owned amongst the users; which artists or genres are popular amongst the users as determined based on numbers of songs, ratings, or playcounts associated with an artist or genre; ratings associated with individual songs, playcounts associated with individual songs; songs which have been recently added to the users' libraries; etc. Based on such factors as well as others, the group playlist generator 234 generates a group playlist containing songs from the users' music libraries which are likely to be preferred or enjoyed by as many of the users as possible, or which satisfy a preference metric.

The streaming logic 236 streams the audio data of the songs in the group playlist to the device 106 for playback by the device 106. The device 106 can be connected (wired or wirelessly) to an audio output device 208 to output the sound so that users A, B, and C may listen to the songs of the group playlist. It will be appreciated that the device 106 can be any device which outputs sound based on information received from device 106, and can be a single device or may include multiple devices. The device 106 will generally include speakers for outputting sound, and an amplifier for amplifying an audio signal. In one embodiment, the device 106 receives the audio signal from user A's device 106. In another embodiment, the device 106 receives audio data, and converts the audio data to an audio signal that is used to drive speakers to output sound.

It is recognized that there may be issues concerning the ownership of digital rights in the music that is streamed from the group playlist. For example, the group playlist may contain a song that is owned by user B, but not user A. In such a case, the song will be streamed to user A's device, even though user A does not own the song. However, user B is present in the vicinity and, by joining user A's group, has authorized playback of songs from user B's library on user A's device. Thus in one embodiment, joining user A's group triggers a digital rights handoff, whereby the rights to playback songs from user B's library are relinquished by user B's device 210 and temporarily assigned to user A's device 106. Therefore, during the playback of the group playlist, user B's device 210 will be unable to playback songs from user B's library. A similar digital rights handoff may occur for user C. In this manner, though users A, B, and C are each logged into the cloud-based music service via their respective devices 106, 210, and 218, playback is effected through user A's device as user A is the host or owner of the group play event in the illustrated embodiment.

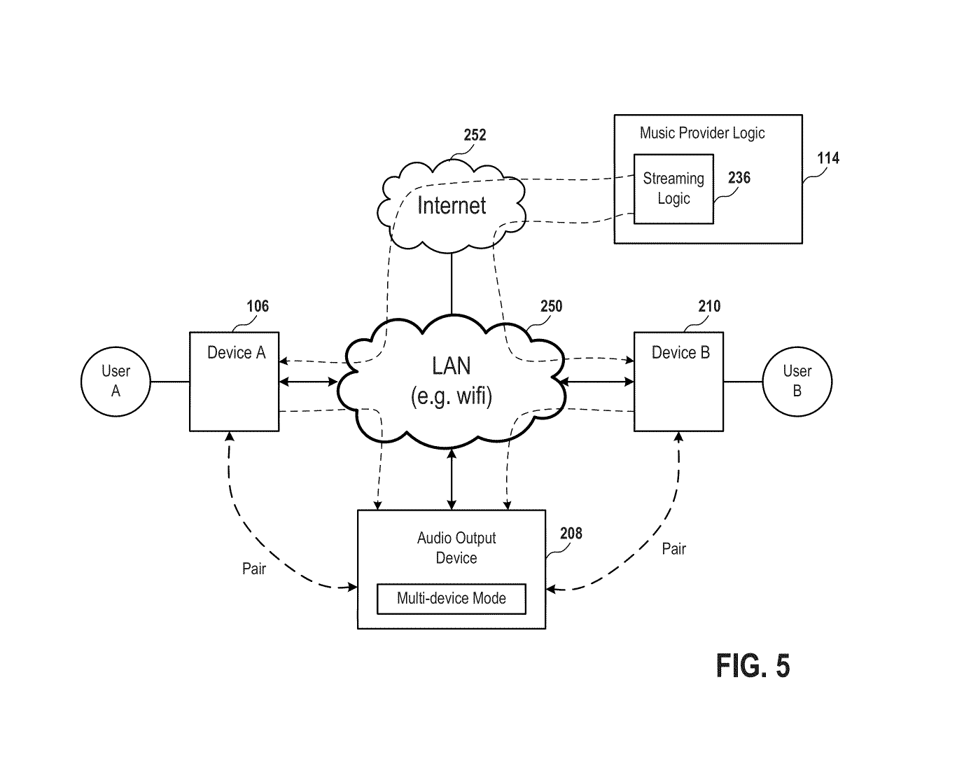

FIG. 5 illustrates a group play mode carried out over a local area network, in accordance with an embodiment of the invention. As shown, each of device 106, device 210, and audio output device 208 are connected to local area network (LAN) 250. LAN 250 can be any type wireless or wired local network, such as a WiFi or Ethernet network. The LAN 250 also provides access to the Internet 252. The devices 106 and 210 are each paired with the audio output device 208 so as to enable devices 106 and 210 to stream audio data to the audio output device 208 over the LAN 250. In one embodiment, the devices 106 and 210 can be configured to detect each other over the LAN 250 to facilitate generation and playback of a group playlist.

As has been described, each of devices 106 and 210 communicates with music provider logic 114 to stream music from their respective users' music libraries. In an embodiment similar to that described with reference to FIG. 4, each of the users A and B may enter a group play mode on their respective devices, with user A “hosting” a group, and user B joining user A's group. Accordingly, the music provider logic 114 may generate a group playlist based on analysis of both user A and user B's music libraries, and stream the group playlist to user A's device 106, which in turn streams audio data over the LAN 250 to the audio output device 208.

In another embodiment, neither user is the “host” of a group, but instead when both devices enter a group play mode, they detect each other over the LAN 250, and communicate with music provider logic 114 to indicate that they are located within a vicinity of each other and are available for the group play mode. The music provider logic 114 generates the group playlist based on analysis of the user's music libraries and streams the group playlist songs to one or both of the devices 106 and 210. In one embodiment, the audio output device 208 may include a multi-device mode which enables the audio output device to simultaneously receive audio data from multiple devices and output the resulting sound. In such an embodiment, the music provider logic 114 may be configured to selectively stream songs of the group playlist to either of devices 106 or 210 depending on which device's owner (user A or B) has a given song in their music library. In other words, songs on the group playlist which are only contained in user A's music library will be streamed to device 106, whereas songs which are only contained in user B's music library will be stream to device 210. Songs which are contained in both user A and user B's music library can be streamed to either of devices 106 and 210.

In still another embodiment, after a group playlist has been generated in response to the users being added to the same group for the group play mode, the music provider logic 114 may stream songs from the group playlist directly to the audio output device 208. Prior to streaming to the audio output device 208, the audio output device will have been identified to the music provider logic and designated as the destination device for streaming of the group playlist.

While the foregoing embodiments have been described with reference to users A and B, this has been done for ease of description. It will be understood by those skilled in the art that the concepts described may be extended to any number of users.

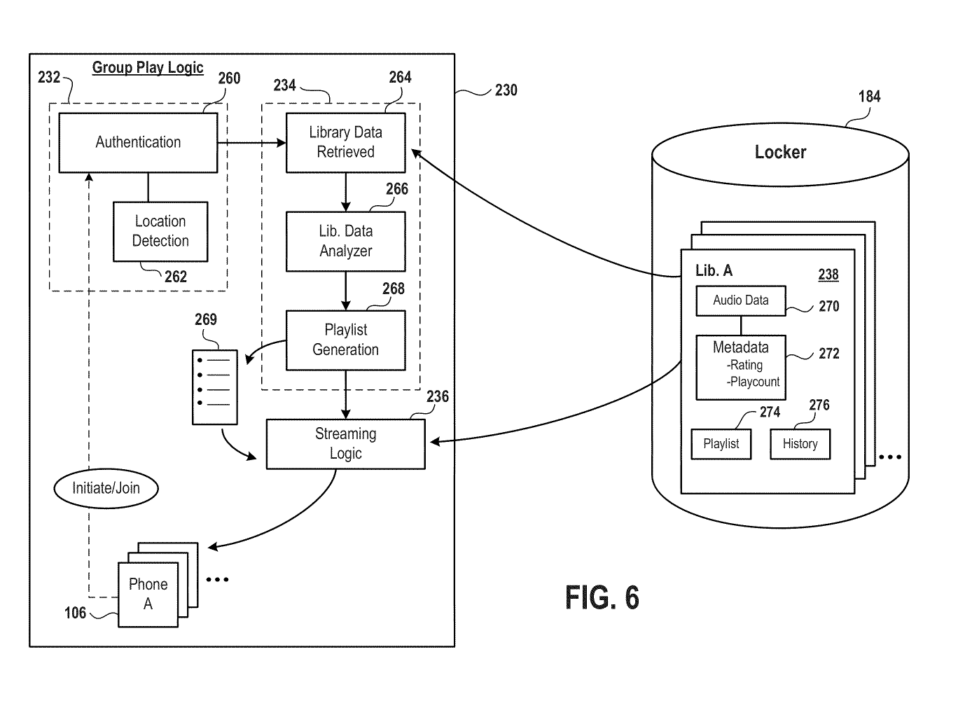

FIG. 6 illustrates systems for data retrieval and playlist generation, in accordance with an embodiment of the invention. As shown, the devices 106 communicate with group play logic 230 to initiate a group and join the group. In one embodiment, the group manager 232 includes an authentication module 260 which authenticates the devices to the group. By way of example, the authentication process may include various methods ensuring inclusion of the appropriate devices in a specific group, such as passcode or password authentication, user ID verification, request/acceptance between users, invitation/acceptance between users, etc. In one embodiment, the group manager 232 includes a location detection module 262 for detecting the location of devices and identifying devices which are in a vicinity of each other. In one embodiment, devices which are found to be in a vicinity of each other can be added to the same group. In another embodiment, location detection can be utilized as a verification tool to confirm that a given device is appropriate for a particular group.

With continued reference to FIG. 6, the group playlist generator 234 includes a library data retrieval module 264 which retrieves data from the group's users' music libraries, the data be subsequently analyzed by a library data analyzer 266 to determine songs from the users' music libraries which are likely to be preferred by as many of the users in the group as possible, or which satisfy a preference metric. A given user's music library 238 includes audio data 270 and metadata 272 associated with individual songs, playlists 274, and history data 276. The metadata can include various characteristics, such as artist, genre, rating, playcount, date of addition to the library, etc. In one embodiment, by way of example, the metadata is an ID3 tag. The metadata 272 can be retrieved and analyzed to determine songs which satisfy a preference metric, or which are likely to be preferred by the users in the group.

A playlist is a selection of songs from an individual user's music library. A user's playlists 274 can provide an indication of the songs that the user likes, and thus the playlists 274 may be retrieved and analyzed.

A user's history data 276 includes data about the user's historical interactions with the music library. Such historical data may include data regarding addition and removal of songs from the music library, playback history such as dates and times of song playback, etc. For example, recent addition of songs from a particular artist or genre may indicate a current preference for the artist or genre on the part of the user. Whereas removal of songs of a particular artist or genre may indicate a lower level of preference for that artist or genre. Playback dates and times can indicate the current and historical level of interest in a particular song. For example, a song which has received a high number of playbacks which are mostly clustered in the past may not be currently preferred despite the relatively high number of playbacks. Whereas a song with a number of playbacks recently may be of greater current preference, even if the overall number of playbacks of the song is relatively low. In light of the above, a user's history data 276 can reveal much about the user's preferred songs in their music library, and is thus useful for retrieval and analysis to determine a group playlist.

It will be appreciated that the library data analyzer 266 analyzes data from multiple users' music libraries, such as metadata, playlists, and history data. Such analysis can entail comparison of the various types of retrieved data across users, in order to determine which songs are likely to be preferred by the most users in the group, or which satisfy a preference metric. In one embodiment, individual songs are scored based on analysis of the retrieved data, and those scored highest are determined to be the songs most likely to be preferred by the users of the group.

In various embodiments, the preference metric can be defined in any number of ways to facilitate inclusion or exclusion of songs from the group playlist. For example, the preference metric may require a threshold number of users possess a given song in their libraries, e.g. at least two users, a majority of the users, or all of the users. Other example thresholds may be defined for various factors or combinations of factors. For example, there may be a threshold requirement that a given song have a minimum rating or playcount assigned by a minimum number of users, or that a given song have a minimum average playcount or average rating across some or all of the users. It will be appreciated that the examples provided herein are disclosed by way of example, and not by way of limitation.

A playlist generation module 268 generates the playlist based on the performed analysis of data retrieved from the group users' music libraries. The group playlist 269 is then streamed by streaming logic 236, which streams the various songs on the group playlist from the appropriate user music libraries to at least one of the devices 106. In an alternative embodiment, the streaming logic 236 can be configured to stream songs from the group playlist to a dedicated playback device separate from the devices 106.

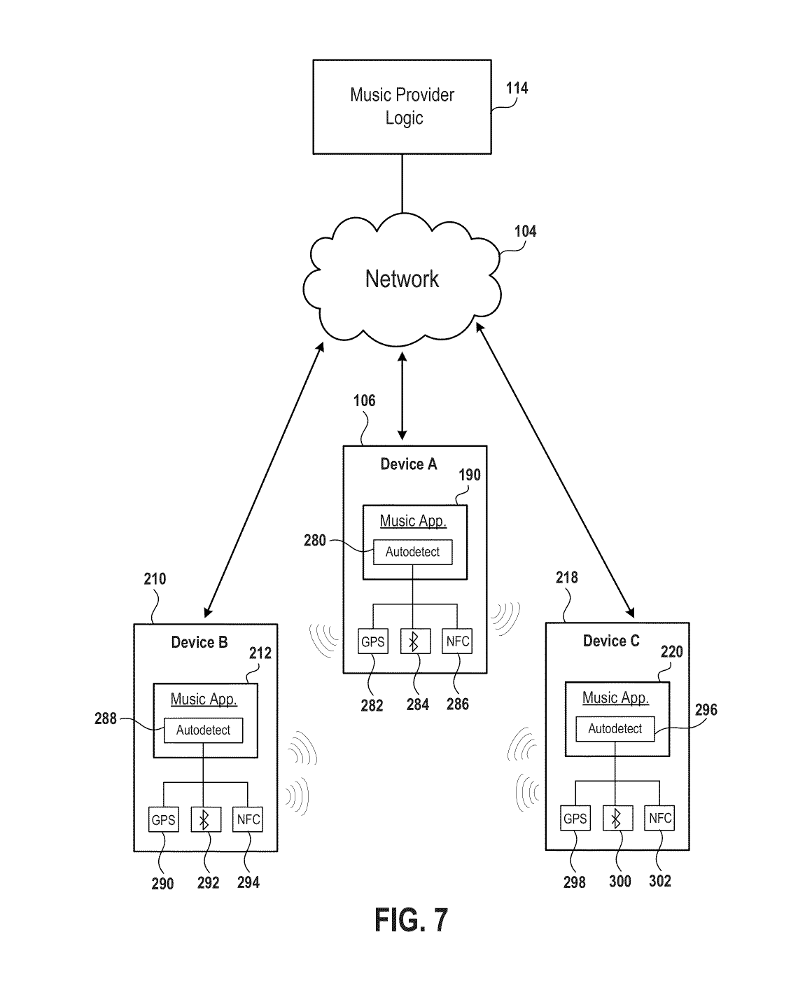

FIG. 7 illustrates automatic detection of devices in a vicinity of each other for a group play mode, in accordance with an embodiment of the invention. In the illustrated embodiment, devices 106, 210, and 218 are located in a vicinity of each other. Each of the devices 106, 210, and 218 executes a music application 140, 212, and 218, respectively, which includes an autodetect module 280, 288, and 296, respectively. The autodetect modules in one embodiment enable the devices to detect each other as being located within the same vicinity. In various embodiments, this determination can then be utilized to initiate the group amongst the devices, provide requests to join a group, provide invitations to join a group, as confirmation of a device as appropriate for addition to a group, etc. The autodetect modules can facilitate detection of devices over a network 104, which can be a LAN or other type of network. In one embodiment, the autodetect modules utilize GPS modules 282, 290, and 298 to determine the location of the devices. In another embodiment, the autodetect modules utilize Bluetooth communications modules 284, 292, and 300 to facilitate detection of the devices amongst each other. In another embodiment, the autodetect modules utilize near field communications (NFC) modules to enable detection of the devices in the same vicinity. It will be appreciated that determining the proximity of devices based on GPS location or a geo-location service may entail determination of locations of the devices as well as determination of distances between the locations of the devices. Whereas in the case of detection of devices via a LAN, NFC, or Bluetooth, the short-range nature of these technologies is such that a successful communication between two devices can be a positive indication of their proximity to each other.

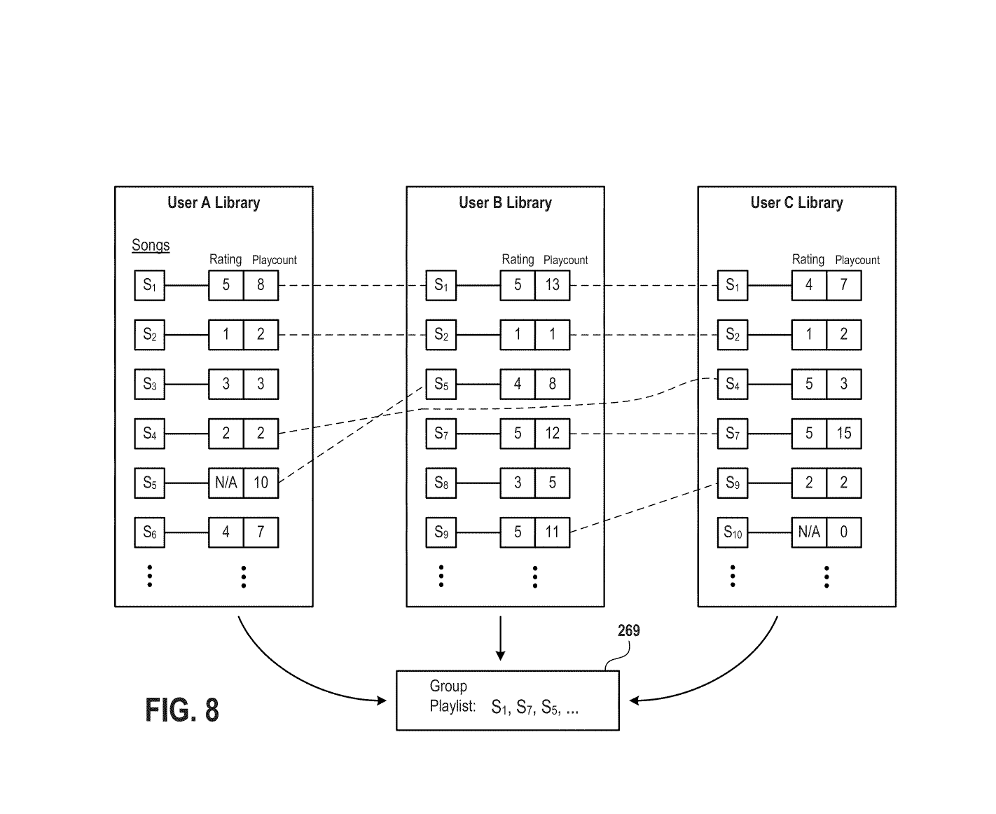

FIG. 8 illustrates one example of a plurality of users' music libraries containing songs which are analyzed to determine a group playlist, in accordance with an embodiment of the invention. As shown, users A, B, and C's music libraries include various songs Sn, each of which has associated metadata including a rating and a playcount. In one embodiment, the rating can be a whole number ranging from one to five, with five being the highest rating, or unrated. In other embodiments, the rating may have any range or incremental unit. The playcount indicates the number of times the song has been played. As has been noted, the selection of songs which are chosen for inclusion in the group playlist 269 may be based on analysis of common ownership of songs, rating, and playcount, among other factors.

In the illustrated embodiment, both songs S₁ and S₂ are contained in each of users' A, B, and C's music libraries. Song S₁ has received high ratings and has high playcounts associated with each user. Therefore, song S₁ is chosen for inclusion in the group playlist 269. However, even though song S₂ is contained in each of the users' music libraries, song S₂ has received low ratings and low playcounts from all of the users, and is therefore not chosen for inclusion in the group playlist.

As shown, song S₇ is owned by each of users B and C, but not user A. Song S₇ has high ratings and high playcounts from the users B and C, and is therefore included in the group playlist. Song S₅ is contained in each of users A and B's music libraries. In user B's library, song S₅ has a high rating and playcount. In user A's library, song S₅ is unrated, but has a high playcount. Despite the lack of a rating, based on the high playcount, it can be inferred that user A likes song S₅. In view of these circumstances, song S₅ is included in the group playlist. Songs S₄ and S₉ are each owned by two users; however, in each case, one of the users rates the song poorly and has seldom played it. Therefore, songs S₄ and S₉ are not included in the group playlist.

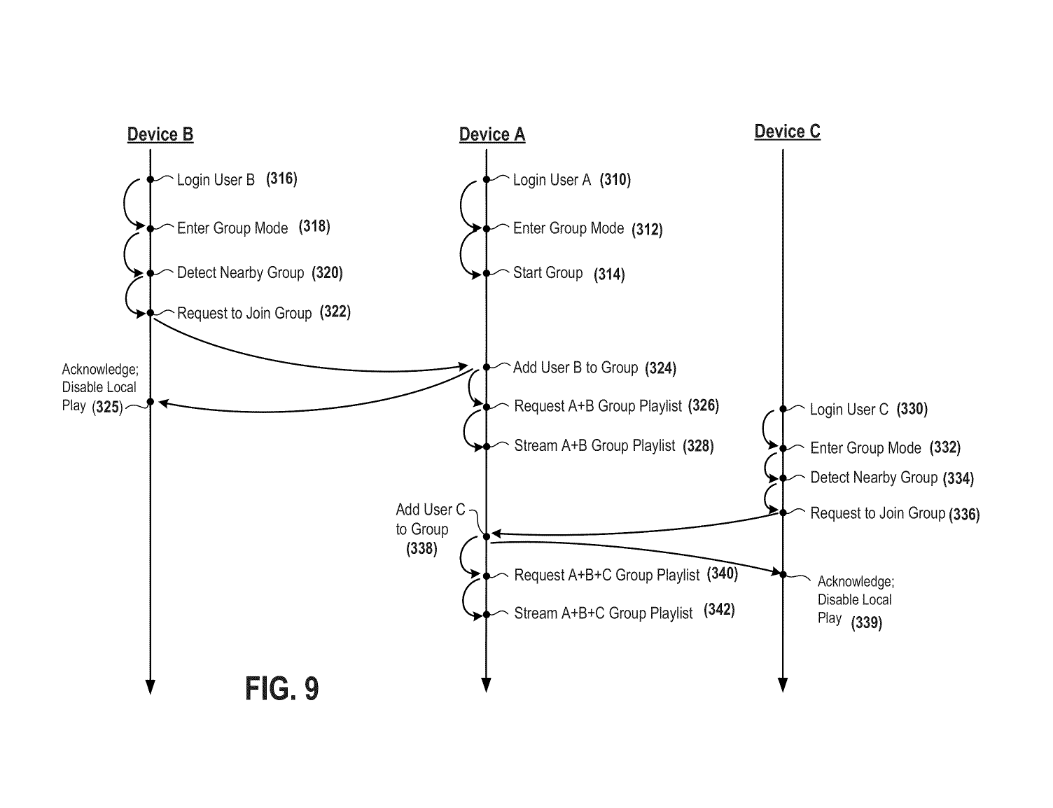

FIG. 9 illustrates timelines of operations associated with various devices, in accordance with an embodiment of the invention. Shown are timelines for devices A, B, and C which correspond to users A, B, and C, respectively. At operation 310 user A performs a login operation to the music service from device A. At operation 312, user A places device A into a group play mode, and at operation 314, user A initiates a group. Meanwhile, at operation 316, user B logs in to the music service via device B and also enters a group play mode at operation 318. At operation 320, device B searches for nearby groups, and detects user A's group. At operation 322 user B sends a request from device B to join user A's group. At operation 324, user A receives user B's request at device A and adds user B to the group. An acknowledgement is sent to device B, which is received at operation 325, whereupon local playback of user B's library at device B is disabled in favor of group playback on user A's device. At operation 326, a request is sent to the music service requesting a group playlist. A group playlist is subsequently generated based on analysis of user A and user B's music libraries. At operation 328, the songs from the group playlist are streamed to device A.

Meanwhile, at operation 330, user C logs in to the music service via device C. At operation 332, user C places device C into group play mode, and at operation 334, device C searches for nearby groups and detects user A's group. A request is sent to device A to join the group at operation 336. At operation 338, user A receives the request at device A and adds user C to the group. An acknowledge is sent to device C, which is received at operation 339, whereupon local playback of user C's music library is disabled at device C. At operation 340, a new or updated group playlist is requested from the music service based on the new addition of user C to the group. In response a new or updated playlist is generated and at operation 342, the songs of the playlist are streamed to device A.

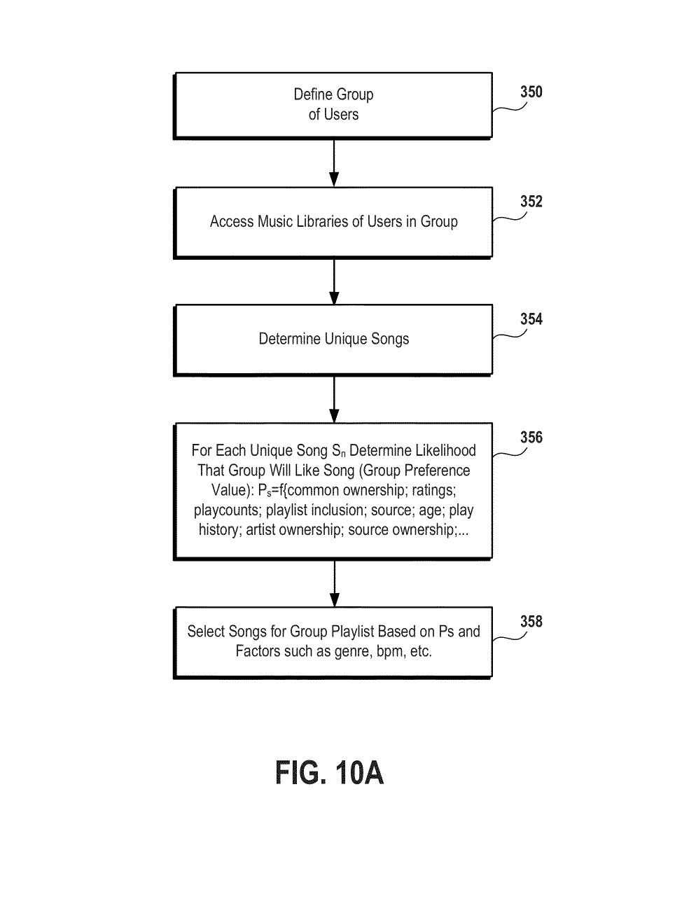

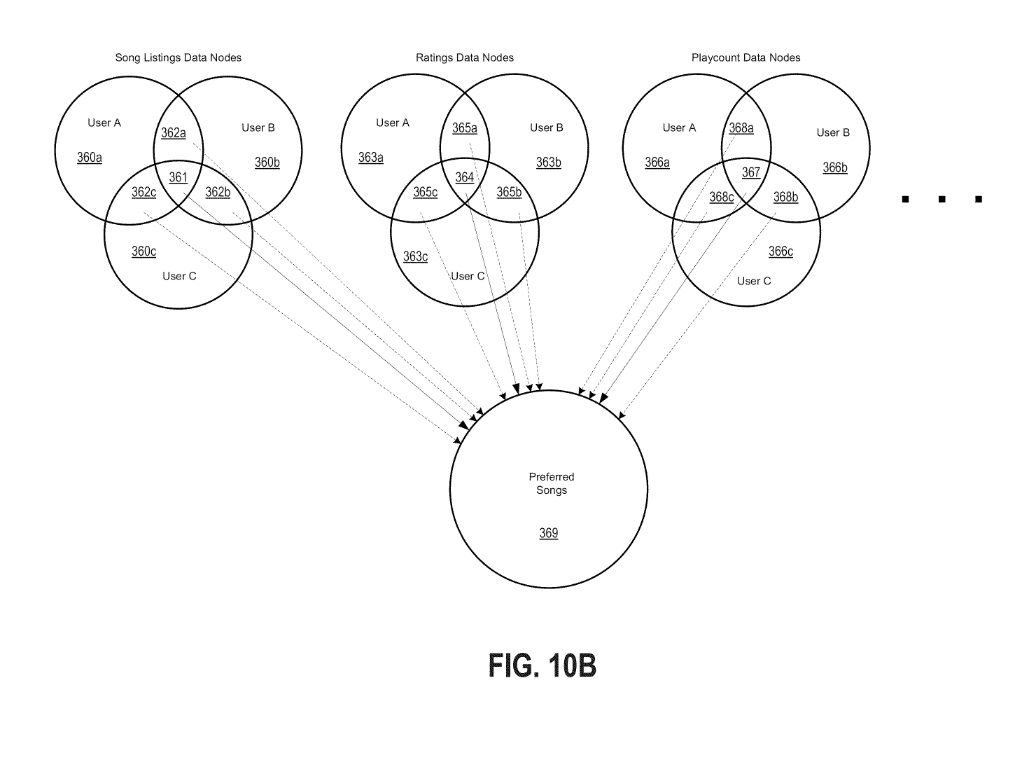

FIG. 10A illustrates a method for determining songs for inclusion in a group playlist, in accordance with an embodiment of the invention. At method operation 350, a group of users is defined for which a group playlist will be generated. At method operation 352, the music libraries of the users in the group are accessed to enable retrieval information such as the metadata of songs in the libraries, playlists, and historical data about the users' interactions with songs in their music libraries. At operation 354, the unique songs across the music libraries of all the users in the group are determined. At operation 356, for each unique song, a group preference value is determined as a function of various factors.

The various factors can include the following: common ownership, which indicates how many of the users own a given unique song; ratings associated with the song; playcounts indicating how many times the song has been played; playlist inclusion, which indicates to what extent the song is included in playlists amongst the users; the source of the song for a given user, such as whether the song was purchased from an online music store, ripped from a cd, uploaded from a drive, etc.; age of the song, i.e. how long since the song was uploaded to a given user's music library; play history of the song, indicating when the song was played by a given user; artist ownership amongst the users, indicating to what extent the artist associated with the song is commonly owned, or to what extent other songs of the artist are owned; genre ownership, indicating the extent to which the genre associated with the song is represented in the users' music libraries; etc.

In one embodiment, the function for determining the group preference value of a given song includes applying various weights to the factors. In one embodiment, the weighting applied to various factors is customizable by a user, so that the user may affect the relative importance of a particular factor in determining the group preference value, and therefore affect the selection of songs for the group playlist.

At operation 358, the songs with the highest group preference value are selected for inclusion in the group playlist. The specific ordering of the songs on the group playlist can be determined based on various factors such as the genres of the selected songs, song tempos, and other song characteristics so as to provide a desirable sequence of songs for the playlist.

In another embodiment, the group preference value is utilized to determine a ranked order of the unique songs. The ranked order thus indicates the relative likelihood that a song will be preferred by all or as many of the users of the group as possible.

In another embodiment, songs which are likely to be preferred by as many of the users in the group as possible are determined by analyzing the music libraries of the users to determine intersections of various library data nodes associated with each of the users' music libraries. The library data nodes define characteristics of the users' music libraries, such as the listings of songs, the ratings of songs, the playcounts of songs, etc. Intersections between the corresponding library data nodes of the different users' libraries are utilized to determine those songs which are likely to be preferred by the group of users. By way of example, with reference to FIG. 10B, library data nodes 360a, 360b, and 360c indicate the listings of songs contained in the music libraries of users A, B, and C, respectively. The intersection 361 of the nodes indicates those songs which are found in all of the users' libraries. Whereas the intersections 362a, 362b, and 362c indicate those songs which are found in two of the three users. Similarly, ratings data nodes 363a, 363b, and 363c indicate ratings of songs in the music libraries of users A, B, and C, respectively. The intersection 364 indicates those songs found in each of the users' libraries which are highly rated by each of the users, respectively. Whereas the intersections 365a, 365b, and 365c indicate those songs which are highly rated by two of the three users. Likewise, playcount data nodes 366a, 366b, and 366c indicate the playcounts of songs in the music libraries of users A, B, and C, respectively. The intersection 367 indicates those songs which have a high playcount amongst all of the users A, B, and C. Whereas the intersections 368a, 368b, and 368c indicate those songs which have a high playcount amongst two out of the three users.

The intersections of the various corresponding library data nodes for the users' music libraries are utilized to determine a pool of preferred songs 369. Depending upon the number of songs desired, the pool of preferred songs 369 may include some or all of the songs from the various intersections. The songs from the intersections of all of the users' corresponding data nodes (reference 361, 364, and 367) are more likely to be preferred by all of the users than those from intersections of only two of the three users (reference 362a-c, 365a-c, and 368a-c). In one embodiment, only songs from intersections of data nodes of all of the users are included in the pool of preferred songs 369. Whereas in other embodiments, the songs from intersections of data nodes of some but not all of the users are included as well.

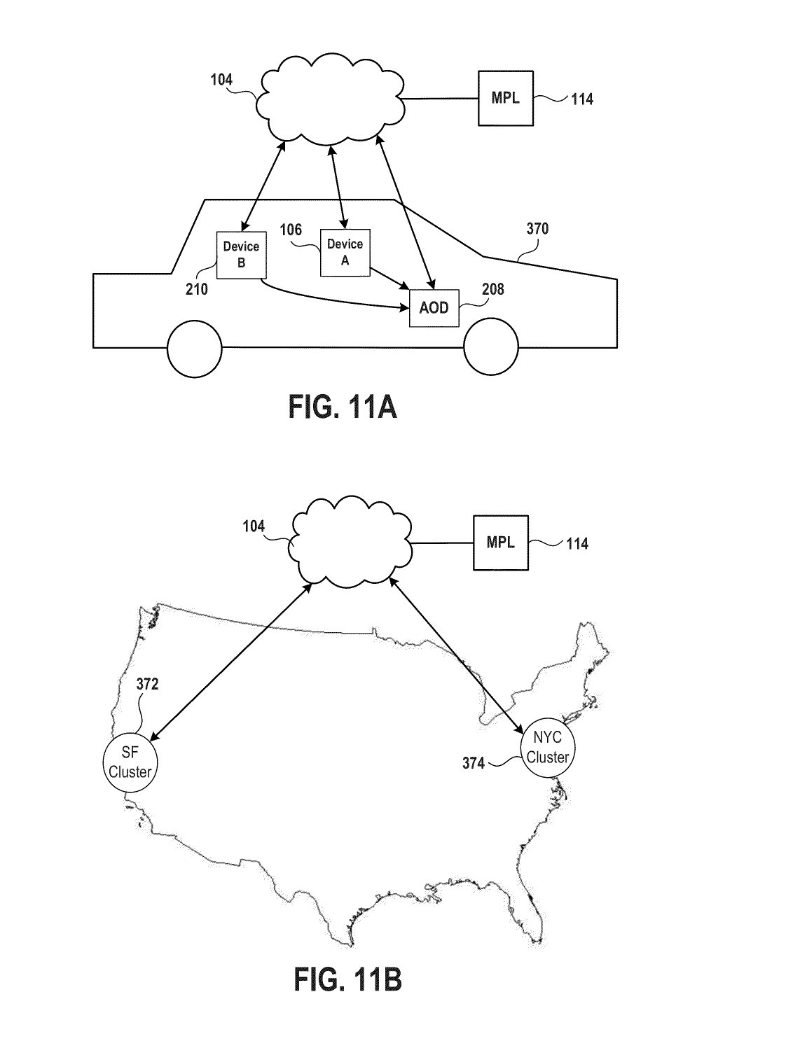

FIG. 11A illustrates group playback in the context of a vehicle, in accordance with an embodiment of the invention. As shown, devices 106 and 210 are located within vehicle 370. The devices communicate with music provider logic 114 via network 104 to enable generation and streaming of a group playlist based on music libraries of the users associated with the devices 106 and 210. In one embodiment, the group playlist can be streamed to either or both of devices 106 or 210, which connect to audio output device 208 for outputting the actual sound. In another embodiment, the group playlist can be streamed directly to the audio output device 208. It will be appreciated that in various embodiments, the vehicle 370 can be any type of vehicle, such as a car, boat, airplane, etc.

FIG. 11B illustrates regionally disparate clusters of users participating in the same group playlist streaming event, in accordance with an embodiment of the invention. As shown by way of example, there are local clusters of users including a local cluster 372 in San Francisco and a local cluster 374 in New York City. In accordance with principles described herein, it is possible for both clusters of users to be part of the same group, for which a group playlist is generated and streamed to both locations. In this manner, the users of both local clusters 372 and 374 are able to enjoy the same music which is likely to be preferred by as many of all the users as possible.

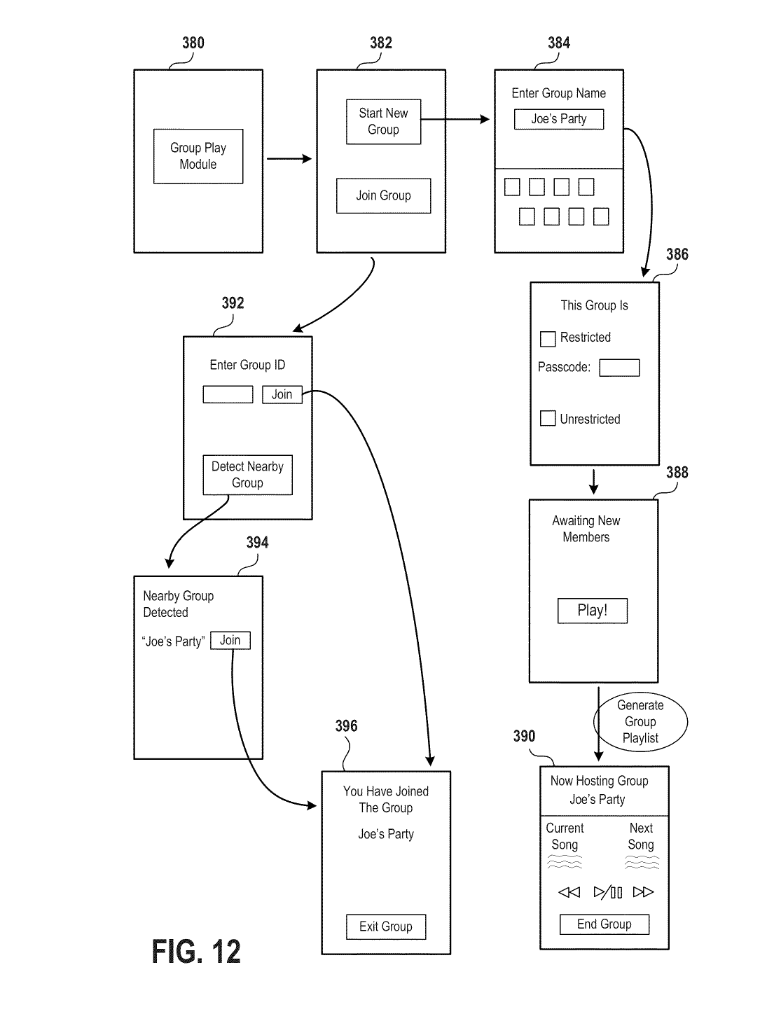

FIG. 12 illustrates a series of interface views for configuring a group play mode, in accordance with an embodiment of the invention. The various interface views may be displayed on a screen of a device to provide an interface for users to access and configure the group play mode. At interface view 380, a group play mode button is provided, whereby the user may enter a group play mode. At interface view 382, the user is presented with options to start a new group or join an existing group.

If the user chooses to start a new group, then at interface view 384, an entry box is provided for entering the name of the group which the user wishes to start. At interface view 386, the user is provided options for making the group restricted with a passcode, or unrestricted. At interface view 388, the system awaits new members to join the group. When members have joined to the user's satisfaction, then the user may press a play button to initiate generation of a group playlist. Then at interface view 390, the user is provided a display indicating that the user's device is hosting a group. The interface view 390 additionally includes information about a current song being played, and a next song, as well as playback controls, and a button to end the group play mode.

With reference to the interface view 382, if the user chooses to join a group, then at interface view 392, an entry field is provided for entering a group ID. Optionally, a passcode may also be required. Also, a button to automatically detect nearby groups is provided. If pressed, then the device will search for nearby existing groups, and at interface view 394, provide options to join any nearby groups which are found. At interface view 396, confirmation is provided that the user has joined a specific group, and a button is also provided for enabling the user to exit the group.

The foregoing embodiments have broadly been described with reference to a cloud-based music service which remotely stores users' music libraries and streams music to network-connected devices. However, in other embodiments, the principles described herein for determining a group playlist and playing songs from the group playlist can be applied in the context of users whose music libraries are locally stored on networked devices. For example, a plurality of users utilizing a plurality of networked devices in a vicinity of each other may collectively form a group for generation and playback of a group playlist. Formation of the group may be in accordance any of the above-described methods, such as via initiation by a host user with other users joining the host user's group, or via automatic detection of nearby devices. As the users' music libraries are stored on the networked devices, the devices may be configured to communicate with each other to generate a group playlist. In one embodiment, the devices communicate data about their respective music libraries to one of the devices that acts as a host device, which in turn analyzes the data about the users' music libraries to generate the group playlist. The group playlist is then played on the host device, with songs which are not already on the host device being streamed from the appropriate other devices which contains the music libraries having those songs.

Additionally, though several embodiments have been described with reference to each user having multiple devices which independently access their music libraries, in other embodiments, it is contemplated that multiple users can crowdsource their music via the same device. For example, when a particular user initiates a group play mode on his device, then there may be an option for additional users to join the group via the same device. This may require the additional users to provide their user ID and password, by way of example, in order to authorize their joining the group for the group play mode.

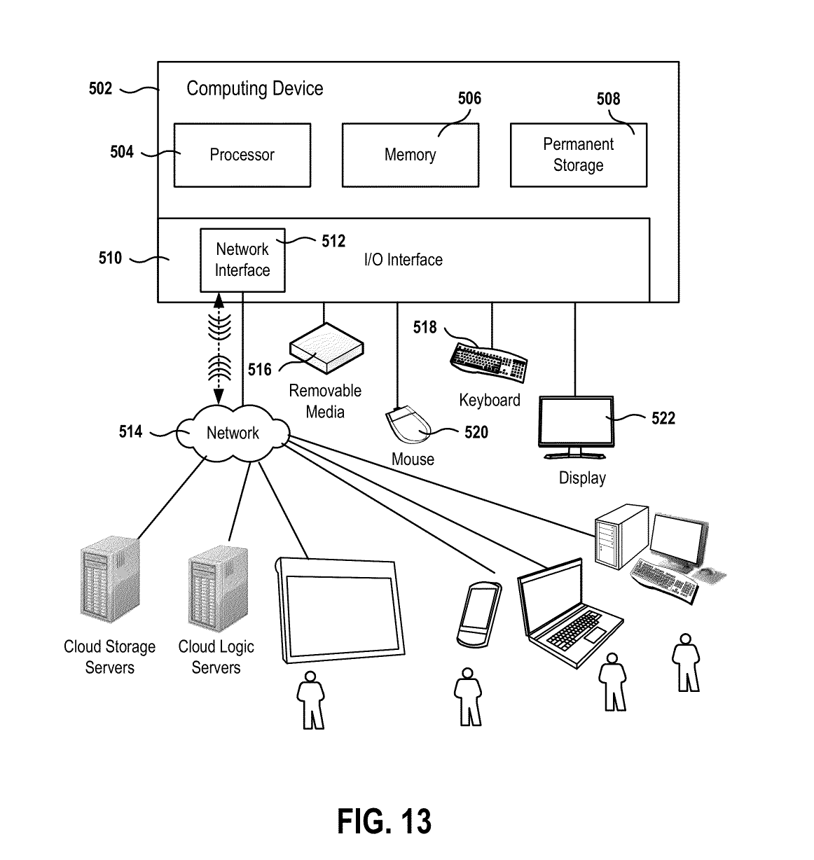

FIG. 13 is a simplified schematic diagram of a computer system 902 for implementing embodiments of the present invention. FIG. 13 depicts an exemplary computer environment for implementing embodiments of the invention. It should be appreciated that the methods described herein may be performed with a digital processing system, such as a conventional, general-purpose computer system. Special purpose computers, which are designed or programmed to perform only one function, may be used in the alternative. The computer system 502 includes a processor 504, which is coupled through a bus to memory 506, permanent storage 508, and Input/Output (I/O) interface 510.

Permanent storage 508 represents a persistent data storage device such as a hard drive or a USB drive, which may be local or remote. Network interface 512 provides connections via network 514, allowing communications (wired or wireless) with other devices. It should be appreciated that processor 504 may be embodied in a general-purpose processor, a special purpose processor, or a specially programmed logic device. Input/Output (I/O) interface 510 provides communication with different peripherals and is connected with processor 504, memory 506, and permanent storage 508, through the bus. Sample peripherals include display 522, keyboard 518, mouse 520, removable media device 516, etc.

Display 522 is configured to display the user interfaces described herein. Keyboard 518, mouse 520, removable media device 516, and other peripherals are coupled to I/O interface 510 in order to exchange information with processor 504. It should be appreciated that data to and from external devices may be communicated through I/O interface 510. Embodiments of the invention can also be practiced in distributed computing environments where tasks are performed by remote processing devices that are linked through a wired or a wireless network.

Embodiments of the present invention can be fabricated as computer readable code on a non-transitory computer readable storage medium. The non-transitory computer readable storage medium holds data which can be read by a computer system. Examples of the non-transitory computer readable storage medium include permanent storage 508, network attached storage (NAS), read-only memory or random-access memory in memory module 506, Compact Discs (CD), Blu-ray™ discs, flash drives, hard drives, magnetic tapes, and other data storage devices. The non-transitory computer readable storage medium may be distributed over a network-coupled computer system so that the computer readable code is stored and executed in a distributed fashion.

Additionally, FIG. 13 shows various types of devices that can connect to the network, such as the internet. The devices include servers, tablet computers, smartphones, laptops, desktops, etc. The various devices an run operating systems and the operating systems can vary from manufacturer to manufacturer.

Some, or all operations of the method presented herein are executed through a processor, such as processor 504 of FIG. 13. Additionally, although the method operations were described in a specific order, it should be understood that some operations may be performed in a different order, when the order of the operations do not affect the expected results. In addition, other operations may be included in the methods presented, and the operations may be performed by different entities in a distributed fashion, as long as the processing of the operations is performed in the desired way.

In addition, at least one operation of some methods performs physical manipulation of physical quantities, and some of the operations described herein are useful machine operations. Embodiments presented herein recite a device or apparatus. The apparatus may be specially constructed for the required purpose or may be a general purpose computer. The apparatus includes a processor capable of executing the program instructions of the computer programs presented herein.

Although the foregoing embodiments have been described with a certain level of detail for purposes of clarity, it is noted that certain changes and modifications can be practiced within the scope of the appended claims. Accordingly, the provided embodiments are to be considered illustrative and not restrictive, not limited by the details presented herein, and may be modified within the scope and equivalents of the appended claims.

What is claimed is:

1. A method for providing music to a group of users, comprising:
detecting a plurality of devices in proximity to each other, each of the devices having an associated user;
for each user, accessing a music library of the user to retrieve a listing of songs contained in the music library and data associated with each of the songs;
analyzing the retrieved listings of songs and the associated data to determine songs satisfying a preference metric;
generating a group playlist of songs based on the songs satisfying the preference metric;
streaming the songs of the group playlist to one of the plurality of devices.

2. The method of claim 1, wherein analyzing the retrieved listings of songs and associated data includes determining commonly owned songs amongst the users.

3. The method of claim 1,
wherein the data associated with each of the songs includes one or more of a rating or a playcount; and
wherein analyzing the associated data includes analyzing the ratings or playcounts of songs.

4. The method of claim 1,
wherein the data associated with each of the songs includes one or more of an artist or a genre; and
wherein analyzing the associated data includes analyzing the artists or genres of songs to determine artists or genres which are popular amongst the users.

5. The method of claim 1,
wherein analyzing the retrieved listings of songs and the associated data includes, for each song in the listings of songs, determining a group preference value based on one or more of the following: a number of the users' libraries that contain the song, ratings associated with the song, or playcounts associated with the song.

6. The method of claim 1, wherein the songs which satisfy the preference metric are defined by intersections of library data nodes of the music libraries of the users, each library data node indicating a characteristic of songs in a given music library.

7. The method of claim 1, wherein detecting the plurality of devices in proximity to each other includes detecting the plurality of devices over a local area network.

8. The method of claim 1, wherein detecting the plurality of devices in proximity to each other includes activating one or more of Bluetooth communication, near-field communication, or a geo-location service.

9. A method for providing music to a group of users, comprising:
detecting a first device associated with a first user, the first user having an online music library;
detecting a second device associated with a second user in a vicinity of the first device, the second user having an online music library;
retrieving data from the online music library of the first user and data from the online music library of the second user;
analyzing the retrieved data to determine songs contained within either of the first user's music library or the second user's music library which satisfy a preference metric;
streaming the songs which satisfy the preference metric.

10. The method of claim 9, wherein the data retrieved from the online music libraries of the first and second users includes metadata associated with songs stored in each of the music libraries.

11. The method of claim 8, wherein the metadata defines one or more of a title, an artist, a genre, a rating, or a playcount.

12. The method of claim 10, wherein streaming the songs includes determining, for a song to be streamed, one of the music libraries containing the song to be streamed, and retrieving the song to be streamed from the one of the music libraries.

13. The method of claim 10,
wherein detecting the first device includes determining a location of the first device;
wherein detecting the second device in the vicinity of the first device includes determining a location of the second device and determining a distance between the location of the first device and the location of the second device.

14. The method of claim 10, wherein detecting the second device in the vicinity of the first device includes detecting a communication between the first device and the second device over one of a local area network, a near-field communication, or a Bluetooth communication.

15. A method for providing music to a group of users, comprising:
initiating a group play mode at a first device, the first device associated with a first user having a first music library, the initiation of the group play mode establishing a group of users;
receiving from a second device a request to join the group of users, the second device associated with a second user having a second music library;
adding the second user to the group of users;
initiating an analysis of the music libraries of the users in the group of users to determine a ranked order of songs in the music libraries, the ranked order based on a preference metric determined for songs in the music libraries;
receiving a streamed group playlist of songs, the songs of the group playlist being selected based on the ranked ordering of songs.

16. The method of claim 15, wherein adding the second user to the group of users includes sending an acknowledge to the second device, receipt of the acknowledge at the second device disabling local playback from the second music library at the second device.

17. The method of claim 15, wherein the music libraries of the users are stored remotely or stored locally.

18. The method of claim 15, wherein the analysis of the music libraries to determine the ranked order of songs includes analyzing metadata associated with songs contained in the music libraries.

19. The method of claim 15, wherein the request to join the group of users is received from the second device via one or more of a remote server, a local area network, or a direct wireless connection.
